(19) United States
(12) Patent Application Publication
(10) Pub. No.: US 2006/0132012 A1
(43) Pub. Date: Jun. 22, 2006

(54) Polymer-thermal shield for ultra-violet lamp

(76) Inventors: Ernest Newton Sumrall, Houston, TX (US); John A. Scialdone, Diamondhead, MS (US)

Correspondence Address: John A. Scialdone, Post Office Box 130, Gulfport, MS, 39502, US

(21) Appl. No.: 11/014,964

(22) Filed: Dec. 20, 2004

(51) Int. Cl. H01J 7/24

(52) U.S. Cl. 313/239; 313/17

(57) ABSTRACT

A device which consists of a germicidal ultra-violet lamp (UVGI Lamp) fitted with a flouro-polymer sleeve, which is heat sealed on each end of the lamp but not allowed to seal over the body of the lamp, thereby providing a thermal barrier for more efficient operation of the lamp in colder temperatures. The UVGI is used for disinfecting surface and airborne mold and bacteria, within the line of sight of the light emission of the device and typically placed in air handlers, air conditioning units, air purifiers, or other devices used to move, transport or purify air, water or other fluids.

### CROSS REFERENCE TO RELATED APPLICATIONS

This application claims the benefit of U.S. Provisional Application No. 60/514590 filed Oct. 27, 2003.

This application differs from prior patents, U.S. Pat. Nos. 6,614,039 and 6,193,894, in that it does not entail the application of flouro-polymer shield or any other type of shield, which is designed to be touching and in proximity with the emitting surface of an ultra-violet lamp, not heat shrinked around the quartz or glass surfaces of the ultra-violet lamp, and is not designed primarily for the purpose of prevention of breakage or to contain glass or other components of the ultra-violet lamp, but is instead a novel application designed specifically for the purpose of creating the opposite effect of sealing the surface of the lamp as described in U.S. Pat. Nos. 6,614,039 and 6,193,894 and instead serves the distinct purpose of creating a uniform gap and air barrier between the flouro-polymer shield and the surface of the ultra-violet lamp, trapping air between the two surfaces, and creating an extremely efficient thermal insulating barrier which is achieved not by contact of the flouro-polymer shield, with the surface of the ultra-violet lamp, but by avoiding contact of the flour-polymer shield with the surface of the lamp and instead substituting insulating air barrier, as described in FIGS. 1 through 4 of the “Diagram of Manufacturing Process.”

### BACKGROUND OF THE INVENTION

This invention relates to a device which consists of a germicidal ultra-violet lamp (UVGI Lamp) fitted with a flouro-polymer sleeve, which is heat sealed on each end of the lamp and loose over the body of the lamp, thereby providing a thermal barrier for more efficient operation of the lamp in colder temperatures.

UVGI has been used for disinfecting surface and airborne mold and bacteria, within the line of sight of the light emission of the device and typically placed in air handlers, air conditioning units, air purifiers, or other devices used to move, transport or purify air, or water/liquids. This invention is unique in that it shrink wraps a flouro-polymer sleeve at opposite ends of the UVGI lamp, sealing both ends of the lamp, but creating insulation barrier of the remaining length of the lamp, between the surface of the UVGI and the exterior surface of flouro-polymer sleeve. This differs from current technology in that it does not utilize the substantially more expensive and cost prohibitive quartz sleeve that is currently used to accomplish an insulating characteristic, and in that it does not utilize a complete heat shrink for the entire length of the light emitting surface of the UVGI lamp and it is not designed for the primary purpose of encapsulating the lamp to prevent breakage to contain the contents of the UVGI lamp.

### BRIEF SUMMARY OF THE INVENTION

A germicidal ultra-violet lamp (UVGI Lamp) fitted with a flouro-polymer sleeve, which is heat sealed on each end of the lamp and loose over the body of the lamp, thereby providing a thermal barrier for more efficient operation of the lamp in colder temperatures.

### BRIEF DESCRIPTION OF THE SEVERAL VIEWS OF THE DRAWINGS

The objects of the invention are achieved as set forth in the illustrative embodiments shown in the drawings which form a part of the specification

FIG. 1 is a diagram of manufacturing process.

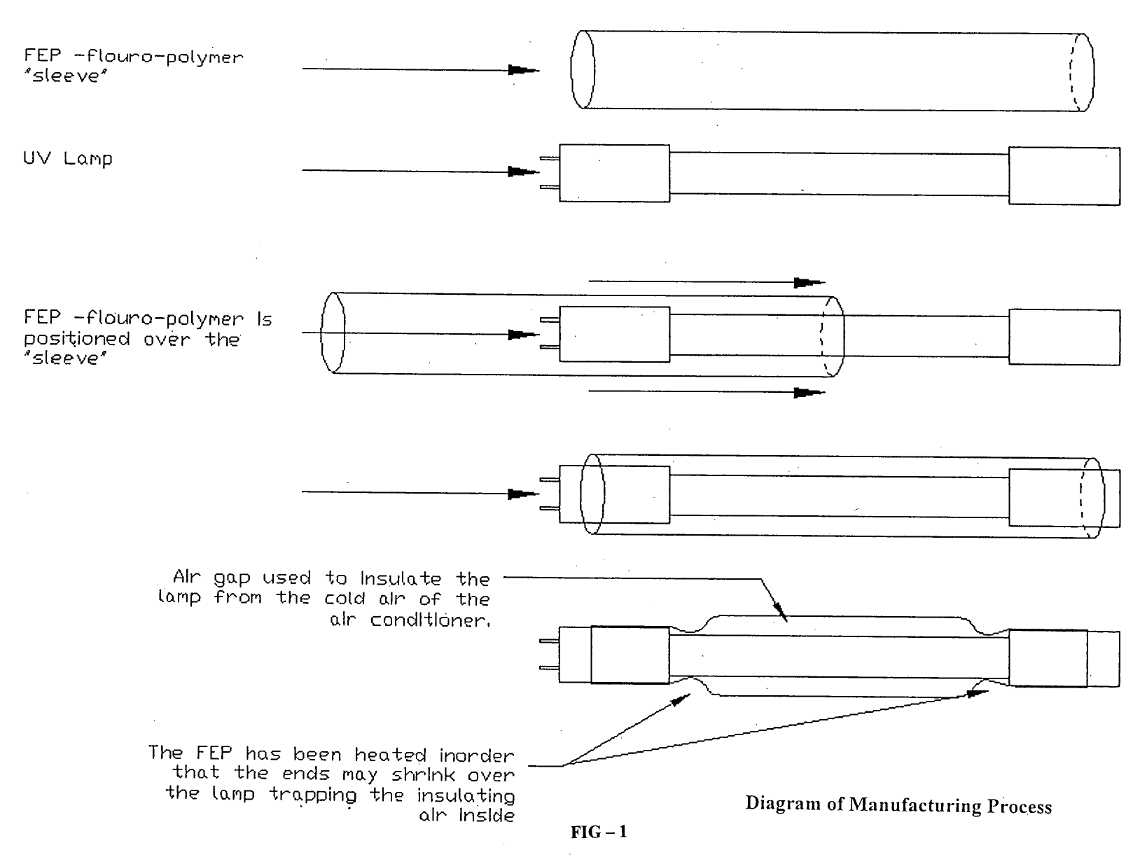

Item 1—flouro-polymer sleeve

Item 2—UVGI Lamp

Item 3—FEP flouro-polymer is positioned over the sleeve

Item 4—air-gap used to insulate the lamp from cold air of AC conditioner and/or other median

Item 5—The FEP has been heat shrinked in order that its ends may shrink over the lamp trapping the insulating air inside.

FIG. 2 is a working model fitted with flouro-polymer sleeve

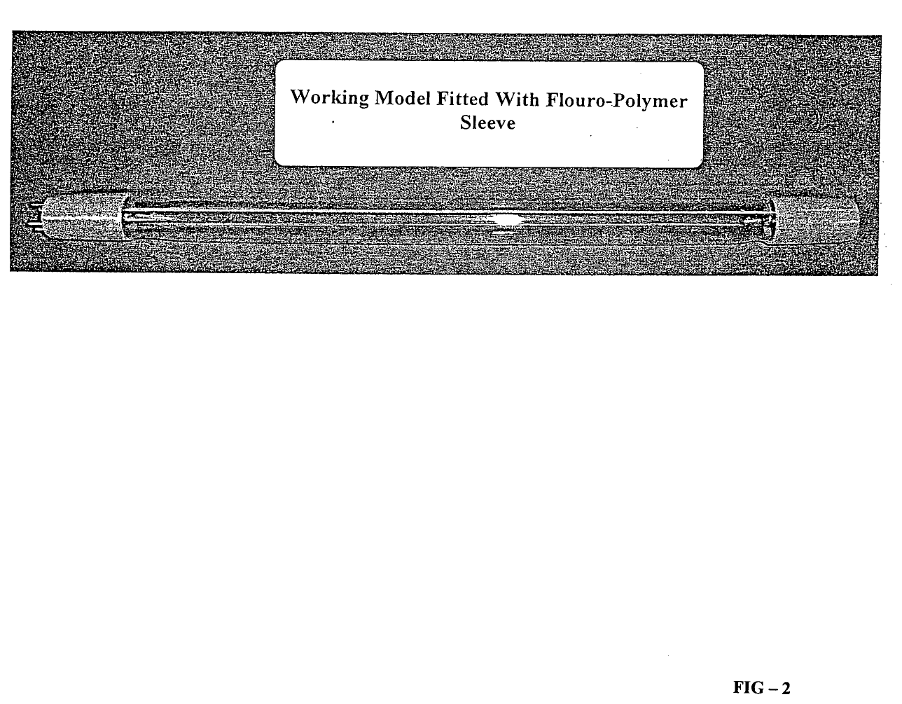

FIG. 3 is a diagram of the UVGI Lamp ceramic end cap without flouro-polymer sleeve

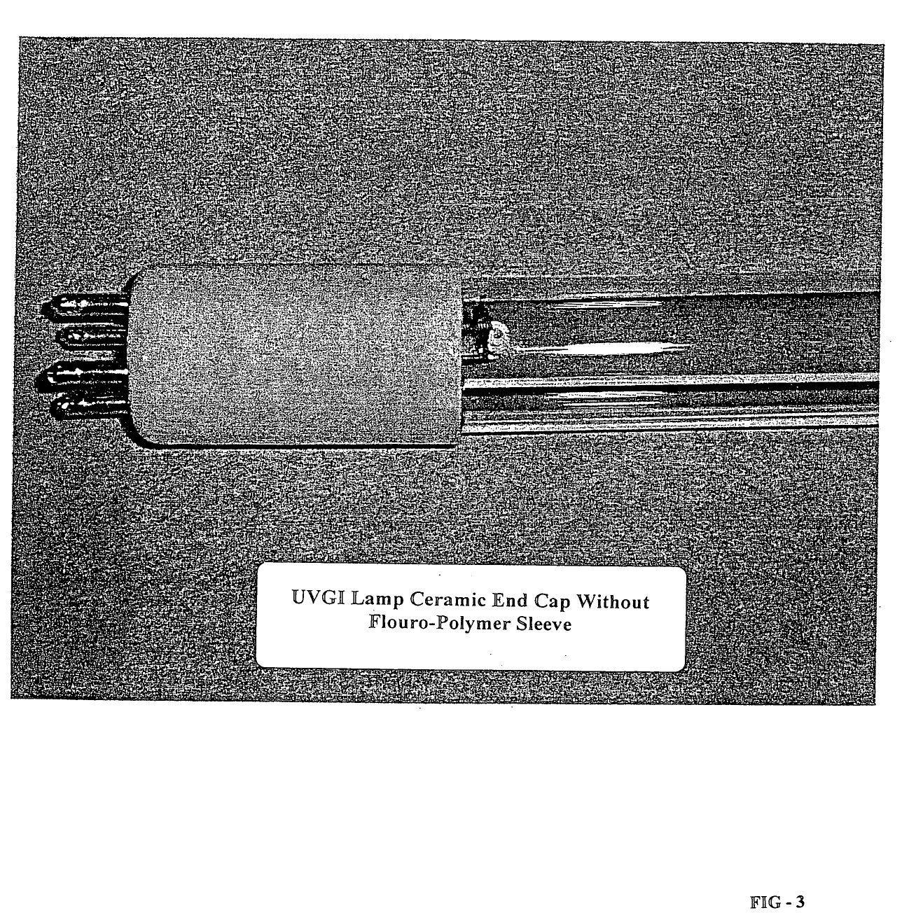

### DETAILED DESCRIPTION OF INVENTION

The device consist of a germicidal ultra-violet lamp (UVGI Lamp) fitted with a flouro-polymer sleeve, which is heat sealed on each end of the lamp and loose over the body of the lamp, thereby providing a thermal barrier for more efficient operation of the lamp in colder temperatures. The UVGI is used for disinfecting surface and airborne mold and bacteria, within the line of sight of the light emission of the device and typically placed in air handlers, air conditioning units, air purifiers, or other devices used to move, transport or purify air. Air purification with this device is used in a number of industry applications including prevention of mold build-up in air conditioning units, air purification for food processing storage and in air purification of industrial, residential and business settings. In their current use, without the specified thermal barrier, these devices can come into contact with lower temperature air which degrades the efficiency of the device. The subject invention uses a flouro-polymer sleeve, encapsulated over the lamp, and configured such that it traps a layer of air between the flouro-polymer sleeve and the surface of the lamp. The invention is further unique in that it shrink wraps the flouro-polymer sleeve at opposite ends of the UVGI lamp, which makes an air tight seal on both ends of the lamp, thereby creating an insulation barrier over the remaining length of the lamp, between the surface of the UVGI and the exterior surface of the flouro-polymer sleeve. This invention differs from current technology in that it does not utilize the substantially more expensive and cost prohibitive quartz sleeve that is currently used to accomplish an insulating characteristic. The current invention is also different from existing technology in that flouro-polymer sleeves are sometimes used as a complete heat shrink for the entire length of the tube, which does not allow dedicated air-insulation barrier to form. The primary purpose of this use of flouro-polymer sleeves applied in a full heat shrink seal over the entire length of the UVGI lamp is to prevent breakage, or injury from breakage, during handling, installation or use of the UVGI lamp although some thermal insulation is also achieved. Specifically, the current use of flouro-polymer sleeves in a full heat shrink application for the length of the UVGI lamp does not create a dedicated air insulation barrier. The process by which the device is created entails application of an FEP or PTFE flouro-polymer shield over the top of the existing UVGI lamp, cutting the shield to length and applying heat over the length of and on the edge of the ceramic surface on each end of the lamp forming a seal over the end sections. The end result of the process described involves a UVGI lamp, covered with a flour-polymer shield, sealed at each end of the ceramic cap and/or additionally sealed at the edges of the ceramic cap, such that the flouro-polymer shield is in contact with and sealing the ends of the lamp, but not in contact and instead maintaining an air barrier around the surface of the UVGI lamp. The air barrier thereby creates insulation around the lamp, allowing it to be more resistant to temperature change, and allowing the lamp to operate more efficiently. This device further allows for significant reduction in manufacturing costs than that available under the current technology.

Having thus described the invention, what is claimed and desired to be secured by Letters Patent is:

1. A germicidal ultra-violet lamp (UVGI Lamp) fitted with a flouro-polymer sleeve, which is heat sealed on each end of the lamp but is left loose over the body of the lamp, thereby providing an air barrier between the glass, quartz or other surface of the lamp and the flouro-polymer sleeve for more efficient operation of the lamp in colder temperatures.

2. A flouro-polymer sleeve, encapsulated over the lamp, and configured such that it traps a layer of air between the flouro-polymer sleeve and the surface of the samp, while forming an air tight seal over each end of the lamp.

3. Application of an FEP or PTFE flouro-polymer shield over the top of the existing UVGI lamp, cutting the shield to length and applying heat over the length of, and on the edge of the ceramic surface on each end of the lamp, forming a seal over the end sections, but without allowing the flouro-polymer shield to touch or be proximity with the surface of the light emitting portion of the lamp.

4. A UVGI lamp, covered with a flour-polymer shield, sealed at each end of the ceramic cap and/or additionally sealed at the edges of the ceramic cap, such that the flouro-polymer shield is in contact with and sealing the ends of the lamp, but not in contact and instead maintaining an air barrier around the surface of the UVGI lamp, and without heat shrinking or sealing the flouro-polymer shield over the light emitting surface of the lamp.
